(19) United States
(12) Patent Application Publication
(10) Pub. No.: US 2012/0144150 A1
(43) Pub. Date: Jun. 7, 2012

(54) DATA PROCESSING APPARATUS

(75) Inventors: Hideru IKEDA, Tokyo (JP); Keisuke NAKAZONO, Tokyo (JP); Tomonori YONEMOTO, Yokohama-shi (JP)

(73) Assignee: OLYMPUS CORPORATION, Tokyo (JP)

(21) Appl. No.: 13/300,745

(22) Filed: Nov. 21, 2011

(30) Foreign Application Priority Data
Dec. 6, 2010 (JP) 2010-271595

(51) Int. Cl. G06F 12/02

(52) U.S. Cl. 711/171; 711/E12.002

(57) ABSTRACT

A data processing apparatus may include a data acquisition unit, a plurality of buffer units including a storage capacity and an additional storage capacity, a valid data amount calculation unit that calculates an amount of valid data and outputs valid data information indicating whether or not the data is valid, and a data write control unit that controls writing of the data to one of the plurality of buffer units. The valid data amount calculation unit may determine the number of the units based on the calculated amount of valid data and the additional storage capacity. The data acquisition unit may acquire data included in the units, the number of which is determined by the valid data amount calculation unit. The data write control unit may control whether or not to write the data to one of the plurality of buffer units based on the valid data information.

### BACKGROUND OF THE INVENTION

1. Field of the Invention

The present invention relates to a data processing apparatus.

Priority is claimed on Japanese Patent Application No. 2010-271595, filed Dec. 6, 2010, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

In an image processing apparatus provided in an imaging apparatus such as a still-image camera, a moving-image camera, a medical endoscope camera, or an industrial endoscope camera, an image processing circuit, which performs a filtering operation and the like alternately using two line buffers, is disclosed, for example, in Japanese Unexamined Patent Application, First Publication No. H8-336114. In the above-described image processing circuit, a still image of one frame is divided into a plurality of blocks, and image processing is performed for each divided block.

FIGS. 6A and 6B are diagrams illustrating a block division method in a pipeline process in accordance with the related art. As shown in FIG. 6A, when a still image of one frame is divided into a plurality of blocks, a flow of image data to be processed within each divided block is continuous, but a flow of data between different blocks is not continuous (see FIG. 6B). Thus, there is a need for a procedure for resetting an image processing circuit and resetting a range of image data corresponding to the next block to be processed, or the like every time processing of one block is completed.

When an operation of the image processing circuit is controlled for each block processing, a period of time loss in which the image processing circuit does not operate occurs during each block processing as described above. A loss time in which the image processing circuit does not operate affects a total processing time of a pipeline process of processing a still image of one frame.

Technology for reducing time loss in processing between blocks in the pipeline process is disclosed, for example, in Japanese Unexamined Patent Application, First Publication No. 2010-176606. In the technology disclosed in Japanese Unexamined Patent Application, First Publication No. 2010-176606, an interrupt signal (process completion interrupt signal) indicating that a process by a processing circuit is completed for each processing circuit constituting a pipeline is output to a sequencer, which controls the entire pipeline process. Every time the process completion interrupt signal is input from the processing circuit, the sequencer individually changes settings of the processing circuit. Thereby, the sequencer changes the settings of the processing circuit every time a process of each processing circuit for each block is completed, not every time processing of a divided block is started. In the technology of Japanese Unexamined Patent Application, First Publication No. 2010-176606, the sequencer changes the settings of each processing circuit for every processing circuit as described above, thereby reducing the time loss in processing between blocks and increasing the speed of the pipeline process for a still image of one frame.

However, even when settings change after processing of one block is completed and then processing of the next block is started in a state in which the technology disclosed in Japanese Unexamined Patent Application, First Publication No. 2010-176606 is adopted in processing circuits constituting the pipeline, there is still a processing circuit in which time loss occurs among the processing circuits constituting the pipeline. For example, in a data processing apparatus having access to data stored in an external memory such as a dynamic random access memory (DRAM) connected to a common data bus by a bus transfer of direct memory access (DMA), a loss time is caused by a combination of a size (capacity) or configuration of a buffer for temporarily storing data included in the data processing apparatus and an amount of data to be transferred by a DMA transfer (burst transfer). This is caused by the presence of a break (burst boundary) in data on an external memory because the burst transfer is performed in units of predetermined burst widths.

Hereinafter, an example of the data processing apparatus in which a loss time occurs will be described. FIG. 7 is a block diagram illustrating an example of a schematic configuration of a data processing apparatus in which the loss time occurs in accordance with the related art. The data processing apparatus of the related art shown in FIG. 7 includes two buffers (buffers A and B), a DMA interface (I/F) for acquiring image data (data for block processing) necessary for block processing (image processing) stored in an external memory via a common data bus, a buffer write circuit for writing (storing) the acquired data for block processing to one buffer, a buffer read circuit for reading data for block processing stored in the other buffer and outputting the read data for block processing to an image processing unit, an image process I/F for acquiring image data processed by a data processing apparatus such as another image processing circuit, and an image processing unit for performing image processing using the image data acquired by the image process I/F and the data for block processing input from the buffer read circuit.

In the data processing apparatus of the related art having the configuration as shown in FIG. 7, the data for block processing stored in the external memory is input to an internal buffer (the buffer A or B) via the DMA I/F and the buffer write circuit in synchronization with processing of the image data input from the image process I/F, and the block processing based on each data is performed. A size of the buffer storing the data for block processing is the same buffer size (storage capacity) as an amount of data for block processing DMA-transferred by the DMA I/F so that a process of writing data to the buffer by the buffer write circuit is simplified. That is, the data processing apparatus of the related art shown in FIG. 7 acquires an amount of data for block processing capable of being stored in the one buffer by one DMA transfer from the external memory, and processes each block by alternately using the two buffers for each DMA transfer.

FIG. 8 is a diagram illustrating an example when data is stored in the buffer included in the data processing apparatus in accordance with the related art. In the data processing apparatus of the related art shown in FIG. 7, for example, data for block processing necessary to process a block 5 shown in FIG. 6A is stored in the two buffers via the DMA I/F and the buffer write circuit in the order of Buffer A→Buffer B→Buffer A→Buffer B→Buffer A as shown in FIG. 8. However, a burst boundary of data for block processing to be burst-transferred from the external memory is not necessarily consistent with a boundary of a block to be processed. As shown in FIG. 8, the data for block processing across a data burst boundary when the DMA I/F performs the burst transfer is stored in the buffer. Thus, for example, data for block processing to be unused in block processing of the block 5 is also DMA-transferred like data for block processing to be stored in the buffer A by a first DMA transfer (burst transfer) or data for block processing to be stored in the buffer A by a fifth DMA transfer (burst transfer).

In the data processing apparatus of the related art shown in FIG. 7, the image processing unit performs block processing by alternately reading data for block processing stored in the two buffers via the buffer read circuit. Here, processing timings of the data processing apparatus of the related art when the data for block processing is stored in each buffer as shown in FIG. 8 will be described using FIG. 9. FIG. 9 is a timing chart illustrating an example of a processing timing of each block in the data processing apparatus in accordance with the related art.

First, the DMA I/F stores data for block processing transferred by a DMA transfer (burst transfer) from the external memory in the buffer A via the buffer write circuit. If storing of the data for block processing to the buffer A is completed, the DMA I/F continuously stores the data for block processing transferred by the DMA transfer from the external memory in the buffer B via the buffer write circuit.

If the data for block processing is stored in the buffer A by the DMA transfer, the image processing unit starts block processing of the block 5 by reading some (fractional) data for block processing to be used in the block processing of the block 5 within the data for block processing stored in the buffer A via the buffer read circuit. If the block processing of the block 5 using the data for block processing stored in the buffer A has ended and the data for block processing is stored in the buffer B, the image processing unit continues the block processing of the block 5 by continuously reading the data for block processing stored in the buffer B via the buffer read circuit.

Thereafter, if the block processing of the block 5 using the data for block processing stored in the buffer A has ended and the block processing of the block 5 using the data for block processing stored in the buffer A is unnecessary, the DMA I/F continuously DMA-transfers data necessary for the block processing of the block 5 from the external memory and stores the data for block processing in the buffer A via the buffer write circuit. Thereafter, the DMA I/F DMA-transfers the data necessary for the block processing of the block 5 from the external memory, and sequentially stores the data for block processing in the buffer B and the buffer A via the buffer write circuit.

If the block processing of the block 5 using the data for block processing stored in the buffer B has ended and the data for block processing is stored in the buffer A, the image processing unit continues the block processing of the block 5 by continuously reading the data for block processing stored in the buffer A via the buffer read circuit. Thereafter, the image processing unit sequentially performs the block processing of the block 5 by use of the data for block processing stored in the buffer B and the buffer A.

When storing of last data for block processing of the block 5 (a fifth DMA transfer in FIGS. 8 and 9) to the buffer A has ended, the DMA I/F and the buffer write circuit of the data processing apparatus are reset, and preparation is started for DMA-transferring data necessary for block processing of the next block 6 to be processed from the external memory. Because the last data for block processing to be used in the block processing of the block 5 is stored in the buffer A, data for block processing to be used in the block processing of the block 6 is sequentially stored from the buffer B. More specifically, as shown in FIGS. 8 and 9, data is stored in the two buffers via the DMA I/F and the buffer write circuit in the order of Buffer B→Buffer A→Buffer B→Buffer A→Buffer B as shown in FIGS. 8 and 9.

However, because the block processing of the block 5 using the data for block processing stored in the buffer B has not ended when storing of the last data for block processing to the buffer A using the block processing of the block 5 is completed, the DMA transfer of data necessary for the block processing of the block 6 cannot be started. Thus, the DMA I/F waits for the DMA transfer (burst transfer) until the block processing of the block 5 using the data for block processing stored in the buffer B is ended. After the block processing of the block 5 using the data for block processing stored in the buffer B has ended and the data for block processing stored in the buffer B is unnecessary for the block processing of the block 5, the DMA I/F starts the DMA transfer of the data necessary for the block processing of the block 6.

After the block processing of the block 5 using the data for block processing stored in the buffer B has ended, the image processing unit performs the block processing of the block 5 by continuously reading the last data for block processing stored in the buffer A via the buffer read circuit. The last data for block processing for performing the block processing of the block 5 is some (a fraction of) data for block processing within the data for block processing stored in the buffer A. Thus, the block processing of the block 5 using the last data for block processing stored in the buffer A ends in a comparatively short time. Continuously, the image processing unit is in a state in which the block processing of the block 6 can be started.

However, when the state in which the block processing of the block 6 can be started is reached, a DMA transfer of data necessary for the block processing of the block 6 from the external memory by the DMA IN and storing to the buffer B via the buffer write circuit are not completed. Thus, the image processing unit waits for the block processing of the block 6 until the data necessary for the block processing of the block 6 is stored in the buffer B. Until the data necessary for the block processing is stored in the buffer, that is, until the DMA transfer (burst transfer) is completed, a time in which the image processing unit waits for the block processing to be started (or a delay time of a block processing start) becomes a loss time in the data processing apparatus. This loss time affects the entire processing time of the pipeline process.

### SUMMARY

The present invention provides a data processing apparatus capable of reducing a loss time during each block processing even when data necessary for processing is arranged across a break in a transfer when the data is transferred in the data processing apparatus that alternately switches a plurality of buffers and performs processing for each divided block.

A data processing apparatus may include: a data acquisition unit that acquires data for each predetermined unit of acquiring data; a plurality of buffer units that include a storage capacity and an additional storage capacity, the storage capacity storing an amount of data acquired by the data acquisition unit in one of the predetermined unit of acquiring data, the additional storage capacity storing an amount of data less than the predetermined unit of acquiring data; a valid data amount calculation unit that calculates an amount of valid data within the data acquired by the data acquisition unit, the valid data amount calculation unit outputting valid data information indicating whether or not the data acquired by the data acquisition unit is valid data; and a data write control unit that controls writing of the data acquired by the data acquisition unit to one of the plurality of buffer units by exclusively controlling the plurality of buffer units. The valid data amount calculation unit may determine the number of the units of acquiring data to be acquired by the data acquisition unit in one data acquisition based on the calculated amount of valid data and the additional storage capacity provided in the buffer unit. The data acquisition unit may acquire data included in the units of acquiring data, the number of which is determined by the valid data amount calculation unit. The data write control unit may control whether or not to write the data to one of the plurality of buffer units based on the valid data information output from the valid data amount calculation unit.

The additional storage capacity provided in the buffer unit may be a storage capacity determined based on an acquisition time necessary for the data acquisition unit to acquire data of which an amount is less than the unit of acquiring data, and a processing time necessary to process data of which an amount is less than the unit of acquiring data.

The valid data amount calculation unit may set the number of the units of acquiring data in one data acquisition by the data acquisition unit to 2 if the amount of valid data is equal to or less than the additional storage capacity. The data acquisition unit may acquire data included in two continuous units of acquiring data.

The valid data amount calculation unit may set the number of units of acquiring data in one data acquisition by the data acquisition unit to 1 if the amount of valid data is greater than the additional storage capacity.

The data write control unit may control only data indicated as valid data by the valid data information output from the valid data amount calculation unit within the data acquired by the data acquisition unit to be written to one of the plurality of buffer units.

The data write control unit may output a data write control signal to one of the plurality of buffer units when data indicated as valid data by the valid data information output from the valid data amount calculation unit within the data acquired by the data acquisition unit is written to one of the plurality of buffer units.

According to the present invention, it is possible to reduce a loss time during each block processing even when data necessary for processing is arranged across a break in a transfer when the data is transferred in the data processing apparatus that alternately switches a plurality of buffers and performs processing for each divided block.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram illustrating a schematic configuration of a data processing apparatus in accordance with a first preferred embodiment of the present invention;

FIG. 2 is a diagram illustrating the flow of the block processing in the data processing apparatus 1 in accordance with the first preferred embodiment of the present invention;

FIG. 3A is a diagram schematically illustrating the buffer size of the buffer included in the data processing apparatus shown in FIG. 7 in accordance with the related art;

FIG. 3B is a diagram schematically illustrating the buffer size of the buffer unit 34 included in the data processing apparatus 1 in accordance with the first preferred embodiment of the present invention;

FIG. 4 is a diagram illustrating an example when data for block processing is stored in the buffer included in the data processing apparatus 1 in accordance with the first preferred embodiment of the present invention;

FIG. 5 is a timing chart illustrating an example of the processing timing for each block to be executed in the data processing apparatus 1 in accordance with the first preferred embodiment of the present invention;

FIGS. 6A and 6B are diagrams illustrating a block division method in a pipeline process in accordance with the related art;

FIG. 7 is a block diagram illustrating an example of a schematic configuration of a data processing apparatus in which the loss time occurs in accordance with the related art;

FIG. 8 is a diagram illustrating an example when data is stored in the buffer included in the data processing apparatus in accordance with the related art; and

FIG. 9 is a timing chart illustrating an example of a processing timing of each block in the data processing apparatus in accordance with the related art.

### DETAILED DESCRIPTION OF THE PREFERRED EMBODIMENTS

The present invention will be now described herein with reference to illustrative preferred embodiments. Those skilled in the art will recognize that many alternative preferred embodiments can be accomplished using the teaching of the present invention and that the present invention is not limited to the preferred embodiments illustrated for explanatory purpose.

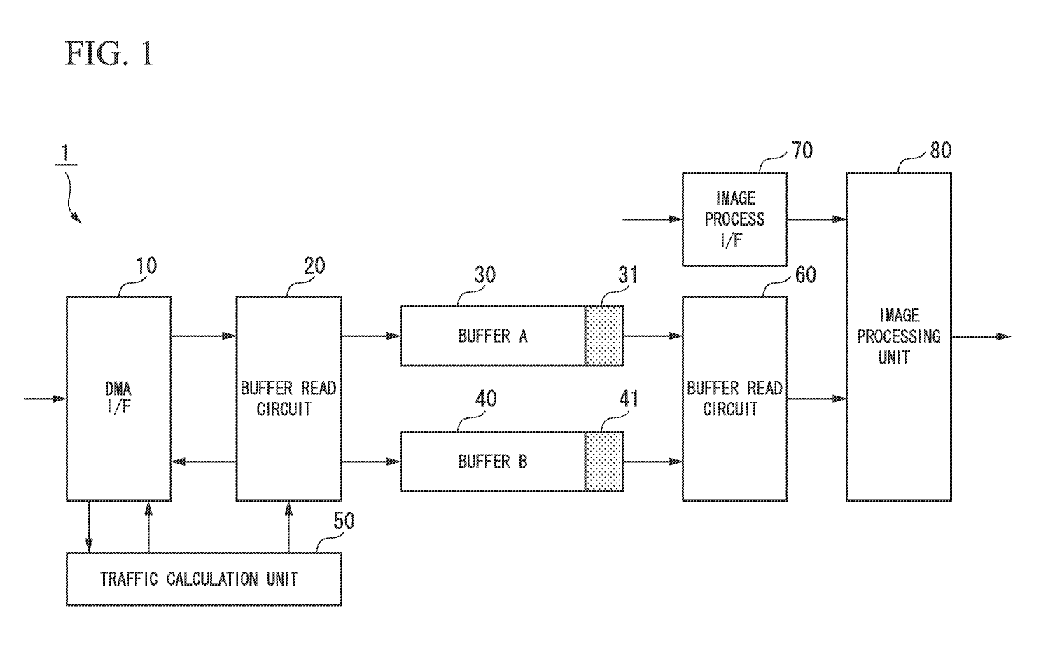

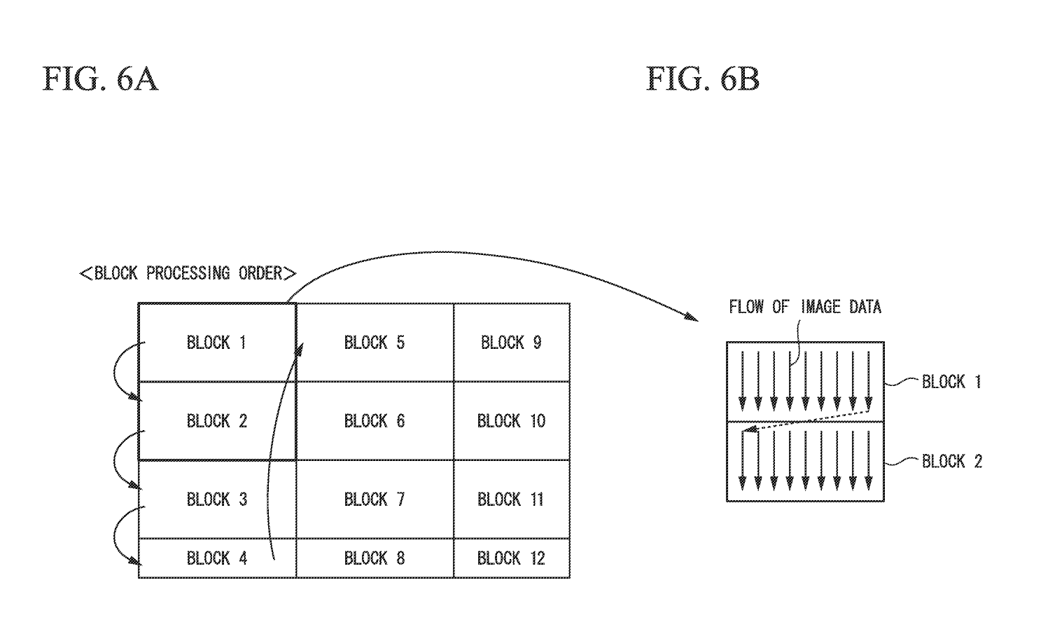

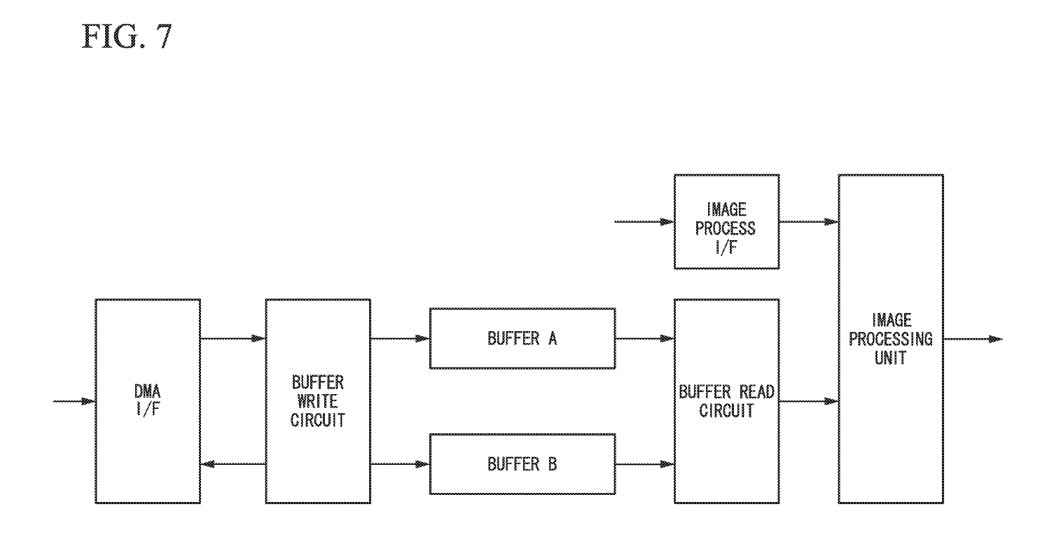

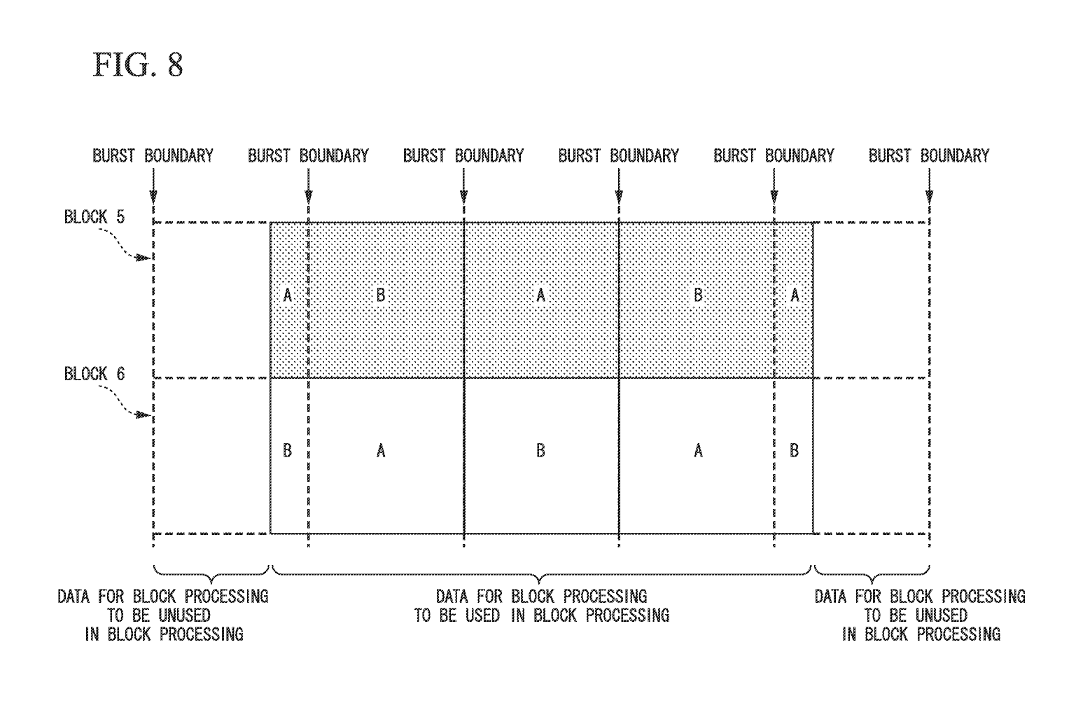

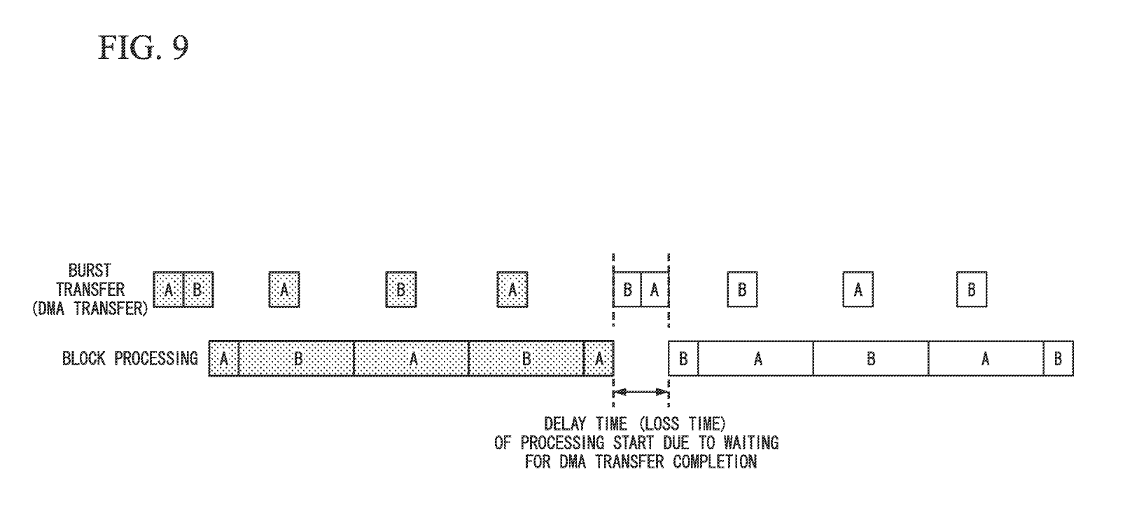

FIG. 1 is a block diagram illustrating a schematic configuration of a data processing apparatus in accordance with a first preferred embodiment of the present invention. The data processing apparatus 1 shown in FIG. 1 includes a DMA I/F 10, a buffer write circuit 20, two buffers (a buffer A (30) and a buffer B (40)), a traffic calculation unit 50, a buffer read circuit 60, an image process I/F 70, and an image processing unit 80. Like the data processing apparatus of the related art shown in FIG. 7, the data processing apparatus 1 divides a still image of one frame into a plurality of blocks as shown in FIG. 6A, and performs block processing (image processing) for each divided block.

More specifically, the DMA I/F 10 acquires image data (data for block processing) necessary for block processing stored in an external memory such as a DRAM connected to a common data bus by a DMA transfer (burst transfer) in synchronization with processing of image data input from the image process I/F 70. The buffer write circuit 20 stores the data for block processing acquired by the DMA I/F 10 in the buffer A (30) or the buffer B (40). The image processing unit 80 reads the data for block processing stored in the buffer A (30) or the buffer B (40) via the buffer read circuit 60, and performs block processing (image processing) using the read data for block processing and the image data input from the image process I/F 70.

A difference between the data processing apparatus 1 and the data processing apparatus of the related art shown in FIG. 7 is that the storage capacity of each of the two buffers (the buffer A (30) and the buffer B (40)) is increased and the traffic calculation unit 50 is added in the data processing apparatus 1. Accordingly, in the following description, only configurations and operations different from the data processing apparatus of the related art shown in FIG. 7 will be described, and detailed descriptions of the same configurations and operations as those of the data processing apparatus of the related art shown in FIG. 7 are omitted.

Each of the buffer A (30) and the buffer B (40) is, for example, a storage unit configured by a static random access memory (SRAM) or the like, which temporarily stores data for block processing. Each of the buffer A (30) and the buffer B (40) has a buffer size (storage capacity) further increased by a predetermined size of storage capacity in addition to the same size of storage capacity as an amount of data for block processing acquired by the DMA IN 10 from the external memory in one DMA transfer. In the following description, when only an increased storage capacity part in the buffer A (30) is indicated, it is referred to as an “additional buffer A (31).” When only an increased storage capacity part in the buffer B (40) is indicated, it is referred to as an “additional buffer B (41).” Sizes of storage capacities of the additional buffer A (31) and the additional buffer B (41) will be described later in detail.

The DMA I/F 10 acquires data for block processing stored in the external memory via the common data bus by the DMA transfer (burst transfer). The DMA I/F 10 outputs the acquired data for block processing to the buffer write circuit 20. A method in which the DMA I/F 10 acquires the data for block processing by the DMA transfer is controlled by the traffic calculation unit 50. The method in which the DMA I/F 10 acquires the data for block processing by the DMA transfer according to control from the traffic calculation unit 50 will be described later in detail.

The buffer write circuit 20 writes (stores) the data for block processing input from the DMA I/F 10 to one buffer of the buffer A (30) and the buffer B (40). Writing of the data for block processing by the buffer write circuit 20 is performed based on information of the data for block processing input from the traffic calculation unit 50. The information of the data for block processing input from the traffic calculation unit 50 and the method of writing (storing) the data for block processing to the buffer A (30) or the buffer B (40) by the buffer write circuit 20 based on the information of the data for block processing will be described later in detail.

The traffic calculation unit 50 controls a method in which the DMA I/F 10 acquires the data for block processing by the DMA transfer. The traffic calculation unit 50 outputs information of the data for block processing to be written to the buffer A (30) or the buffer B (40) by the buffer write circuit 20. Control of the DMA I/F 10 and an output of information to the buffer write circuit 20 by the traffic calculation unit 50 will be described later in detail.

The buffer read circuit 60 reads the data for block processing stored in one buffer of the buffer A (30) and the buffer B (40), and outputs the read data for block processing to the image processing unit 80.

The image process I/F 70 acquires image data processed by a data processing apparatus such as another image processing circuit, and outputs the acquired image data to the image processing unit 80.

The image processing unit 80 performs block processing for each divided block by use of the data for block processing, stored in the buffer A (30) or the buffer B (40), input via the buffer read circuit 60 and the image data input from the image process I/F 70. The image processing unit 80 outputs block-processed data to an outside of the data processing apparatus 1, for example, such as the next image processing circuit.

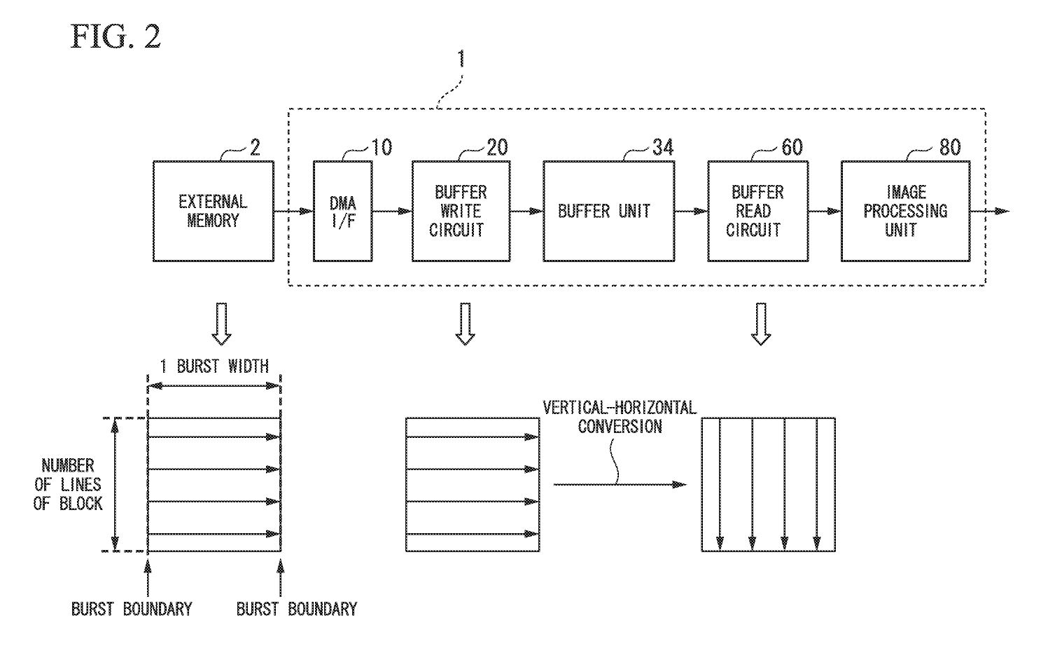

Here, a flow of the block processing in the data processing apparatus 1 in accordance with the first preferred embodiment of the present invention will be described. FIG. 2 is a diagram illustrating the flow of the block processing in the data processing apparatus 1 in accordance with the first preferred embodiment of the present invention. In FIG. 2, a flow of processing until the data processing apparatus 1 acquires data from the external memory 2 and outputs block-processed (image-processed) data and a flow of data read or written in each step are schematically shown. In FIG. 2, the buffer A (30) and the buffer B (40) included in the data processing apparatus 1 are collectively referred to as a “buffer unit 34.” Accordingly, in the following description, the “buffer unit 34” is either of the buffer A (30) and the buffer B (40).

The data for block processing is stored in the external memory 2 in a state in which a flow of data is continuous in a horizontal direction (in raster order). The DMA I/F 10 acquires data for block processing of one burst width from the external memory 2 in one burst transfer. The DMA I/F 10 ends the DMA transfer by performing burst transfers of which the number is the same as the number of lines of the data for block processing acquired from the external memory 2. Accordingly, the DMA I/F 10 acquires data for block processing of (One Burst Width×Number of Lines) from the external memory 2 in one DMA transfer. The one burst width acquired by the DMA I/F 10 through one burst transfer becomes a boundary line of a burst boundary in the external memory 2.

For example, the data for block processing stored in the external memory 2 is stored in a dot-sequential format of YC422 for each frame. In this case, for example, the DMA I/F 10 acquires data for block processing of (One Burst Width (32 Pixels)×Number of Lines) through the DMA transfer.

The buffer write circuit 20 stores the data for block processing acquired by the DMA I/F 10 in the buffer unit 34 in the same type as a type of storage in the external memory 2. Thereafter, the buffer read circuit 60 performs a vertical-horizontal conversion of the data for block processing stored in the buffer unit 34, that is, converts and reads the data so that a flow of data is continuous in a vertical direction, and outputs the data to the image processing unit 80. When the buffer read circuit 60 reads the data for block processing stored in the buffer unit 34, the vertical-horizontal conversion is performed to unify a data flow with image data processed by another data processing apparatus input from the image process I/F 70 to the image processing unit 80. Accordingly, the vertical-horizontal conversion of the data for block processing by the buffer read circuit 60 may not be a necessary process according to the flow of image data input from the image process I/F 70.

The image processing unit 80 performs the block processing using the data for block processing input after the vertical-horizontal conversion by the buffer read circuit 60 and the image data input from the image process I/F 70, and outputs the block-processed data outside the data processing apparatus 1.

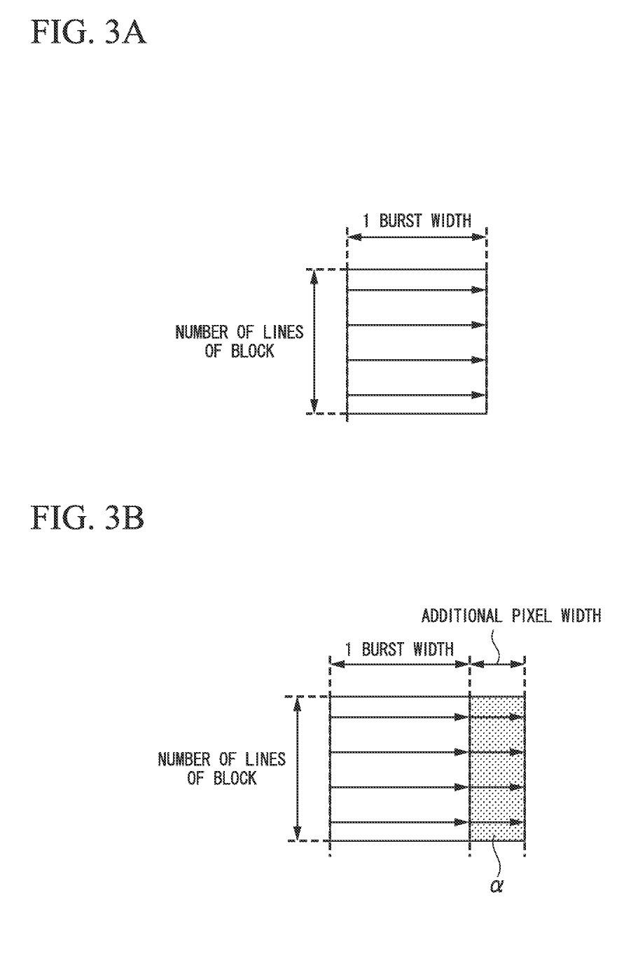

Next, increased storage capacity sizes (or buffer sizes) in the buffer A (30) and the buffer B (40) included in the data processing apparatus 1 in accordance with the first preferred embodiment of the present invention will be described. FIGS. 3A and 3B are diagrams for explaining a buffer size (or storage capacity) of the buffer unit 34 included in the data processing apparatus 1 in accordance with the first preferred embodiment of the present invention. FIG. 3A is a diagram schematically illustrating the buffer size of the buffer included in the data processing apparatus shown in FIG. 7 in accordance with the related art. FIG. 3B is a diagram schematically illustrating the buffer size of the buffer unit 34 included in the data processing apparatus 1 in accordance with the first preferred embodiment of the present invention.

As shown in FIG. 3A, the buffer size of the buffer included in the data processing apparatus of the related art of the configuration as shown in FIG. 7 is one burst width acquired by the DMA I/F in one burst transfer and the number of lines of a block for which the image processing unit performs block processing:

On the other hand, each of the two buffers (the buffer A (30) and the buffer B (40)) included in the data processing apparatus 1 has a buffer size increased by a predetermined size of storage capacity α as described above. The increased storage capacity α in each of the two buffers included in the data processing apparatus 1 is determined based on a processing time necessary for the DMA I/F 10 to acquire the data for block processing and write (or store) the data for block processing to the buffer unit 34 and a processing time when the block processing is performed by the image processing unit 80.

For example, a processing time (or the number of clocks) necessary for a burst transfer of one burst width by the DMA I/F 10 is assumed to be 4 clocks, and the number of lines of a block for which the image processing unit 80 performs the block processing is assumed to be 100, that is, the number of pixels of one vertical line for which the image processing unit 80 performs the block processing is assumed to be 100. In this case, the DMA I/F 10 acquires the data for block processing by the DMA transfer, and a processing time (or the number of clocks) in which the buffer write circuit 20 performs a storage operation in the buffer unit 34 is obtained as shown in the following Equation (1).

4 (clocks)×100 (lines)=400 (clocks) (1)

If a processing time (or the number of clocks) necessary for the image processing unit 80 to perform the block processing of one pixel is set to one clock and a processing time of a storage operation in the buffer unit 34 obtained by the above Equation (1) is converted into the number of vertical lines for which the image processing unit 80 performs the block processing, the following Equation (2) is obtained.

400 (clocks)/100 (pixels)=4 (lines) (2)

That is, a processing time in which the DMA I/F 10 acquires the data for block processing by the DMA transfer and stores the data for block processing in the buffer unit 34 corresponds to a time of block processing of 4 vertical lines in the image processing unit 80. From the above, it can be seen that the storage capacity α added to each of the two buffers included in the data processing apparatus 1 should be equal to or greater than 4 Lines×100 Pixels=400 Pixels. Accordingly, in the data processing apparatus 1, its size of storage capacity α is added to each of the buffer A (30) and the buffer B (40) as the additional buffer A (31) and the additional buffer B (41). As described above, the data processing apparatus 1 in accordance with the first preferred embodiment of the present invention has a configuration including a buffer having an increased buffer size by increasing a buffer included in the data processing apparatus of the related art by a storage capacity of the number of vertical lines (or an additional pixel width) for which the image processing unit 80 can perform the block processing in the same time as the processing time necessary for the DMA I/F 10 to acquire data for block processing and write the data for block processing to the buffer unit 34.

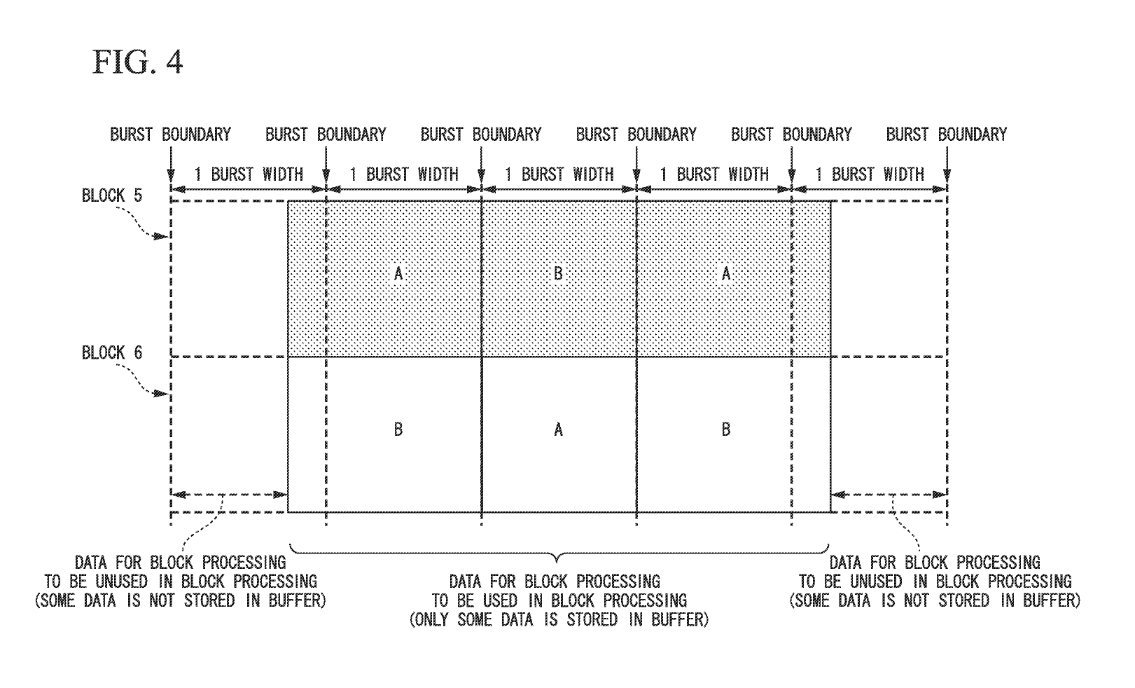

Next, control of the DMA I/F 10 and an output of information to the buffer write circuit 20 by the traffic calculation unit 50 included in the data processing apparatus 1 in accordance with the first preferred embodiment of the present invention will be described. FIG. 4 is a diagram illustrating an example when data for block processing is stored in the buffer included in the data processing apparatus 1 in accordance with the first preferred embodiment of the present invention. FIG. 4 shows the case where data necessary for block processing (image processing) in the data processing apparatus 1 is arranged across a burst boundary in the external memory 2 when the DMA I/F 10 performs burst transfer, and fractional data for block processing, which is less than one burst width, is less than the additional pixel width of the increased storage capacity α in the buffer A (30) and the buffer B (40).

The traffic calculation unit 50 calculates an amount of valid data (hereinafter referred to as a “valid data amount”) for block processing to be used in the block processing of the burst width for each burst width.

The valid data amount is calculated based on values such as an image size of data for block processing, reference coordinates of the block processing (for example, coordinates of an upper left end of a block), a block size, and a storage format of the data for block processing. For example, in the block processing of the block 5 shown in FIG. 4, only some (fractional) data for block processing in first and fifth burst widths is valid data and all data for block processing in second to fourth burst widths is valid data. The traffic calculation unit 50 calculates a valid data amount within each burst width.

The traffic calculation unit 50 determines a burst width of a burst transfer to be performed when the DMA I/F 10 acquires data for block processing by the DMA transfer based on the calculated valid data amount and the storage capacity α added to the buffer.

More specifically, if the valid data amount is equal to or less than the storage capacity α (Valid Data Amount≦Storage Capacity α), that is, if the number of pixels of the horizontal direction of some (fractional) valid data for block processing within data for block processing included in the first burst width is less than the number of pixels of the horizontal direction of the additional buffer A (31) and the additional buffer B (41), the traffic calculation unit 50 determines that the valid data for block processing included in the first burst width and the data for block processing included in the second burst width can be stored in the same buffer unit 34. The traffic calculation unit 50 controls the DMA I/F 10 to acquire data for block processing of two burst widths of the first and second burst widths in one DMA transfer, that is, to perform a DMA transfer of (Two Burst Widths×Number of Lines).

On the other hand, if the valid data amount is greater than the storage capacity α (Valid Data Amount>Storage Capacity α), that is, if the number of pixels of the horizontal direction of some (fractional) valid data for block processing within data for block processing included in the first burst width is greater than the number of pixels of the horizontal direction of the additional buffer A (31) and the additional buffer B (41), the traffic calculation unit 50 determines that the valid data for block processing included in the first burst width and the data for block processing included in the second burst width cannot be stored in the same buffer unit 34. The traffic calculation unit 50 controls the DMA I/F 10 to acquire data for block processing included in the first burst width and data for block processing included in the second burst width separately in two DMA transfers, that is, to perform a DMA transfer of (One. Burst Width×Number of Lines) twice as in the data processing apparatus of the related art.

The traffic calculation unit 50 outputs information for determining whether data for block processing acquired by the DMA I/F 10 using the DMA transfer is valid data to be used in the block processing or invalid data to be unused in the block processing to the buffer write circuit 20 based on the calculated valid data amount.

For example, even when the traffic calculation unit 50 determines that the valid data for block processing included in the first burst width and the data for block processing included in the second burst width can be stored in the same buffer unit 34 and the DMA I/F 10 performs the DMA transfer of (Two Burst Widths×Number of lines), all data for block processing in the first burst width is input to the buffer write circuit 20. That is, because the DMA transfer by the DMA I/F 10 is a data transfer in units of burst widths, it is not that only valid data for block processing included in the first burst width is DMA-transferred.

The traffic calculation unit 50 outputs information for determining valid data for block processing stored in the buffer unit 34 within data for block processing DMA-transferred by the DMA I/F 10 to the buffer write circuit 20. This information is, for example, information indicating a valid data range within the data for block processing input from the DMA I/F 10 to the buffer write circuit 20 or information indicating the number of valid data or the number of invalid data within data for block processing burst-transferred.

The buffer write circuit 20 determines whether the data for block processing is valid or invalid for all data for block processing input from the DMA I/F 10 based on the information for determining the valid data for block processing input from the traffic calculation unit 50, and controls writing to the buffer unit 34 based on the result of determination. For example, no data write control signal is output to the buffer unit 34 if the invalid data for block processing is input from the DMA I/F 10, and the data write control signal is output to the buffer unit 34 only if the valid data for block processing is input from the DMA I/F 10.

The traffic calculation unit 50 may be configured to determine whether the data for block processing is valid or invalid for all data for block processing acquired by the DMA I/F 10. In this case, the traffic calculation unit 50 outputs information (a determination result) indicating whether the data for block processing acquired by the DMA I/F 10 is valid or invalid data to the buffer write circuit 20. The buffer write circuit 20 can be implemented by controlling writing of data to the buffer unit 34 based on the determination result input from the traffic calculation unit 50.

Only if the DMA I/F 10 acquires the valid data for block processing, the traffic calculation unit 50 outputs the information indicating that the data for block processing input from the DMA I/F 10 is the valid data to the buffer write circuit 20. Only if the information indicating that the data for block processing is the valid data is input from the traffic calculation unit 50, the buffer write circuit 20 can be implemented by outputting the data write control signal to the buffer unit 34.

For example, in the block processing of the block 5 in an example in which the data for block processing shown in FIG. 4 is stored in the buffer by the above-described control, data for block processing of two burst widths, the first and second burst widths, is acquired in a first DMA transfer and stored in the buffer A (30). Data for block processing of the third burst width is acquired in a second DMA transfer and stored in the buffer B (40). The data for block processing of two burst widths, the fourth and fifth burst widths, is acquired in a third DMA transfer and stored in the buffer A (30). Further, in block processing of a block 6, the data for block processing is stored in the two buffers via the DMA I/F 10 and the buffer write circuit 20 in the order of Buffer B (40)→Buffer A (30)→Buffer B (40).

In the data processing apparatus 1 in accordance with the first preferred embodiment of the present invention as described above, even when a burst boundary in the external memory 2 of data for block processing burst-transferred from the external memory 2 is not consistent with a boundary of a block to be processed, it is possible to store only the valid data for block processing acquired by the DMA I/F 10 in the buffer unit 34. Thereby, the data processing apparatus 1 in accordance with the first preferred embodiment of the present invention can easily process data without increasing a buffer size.

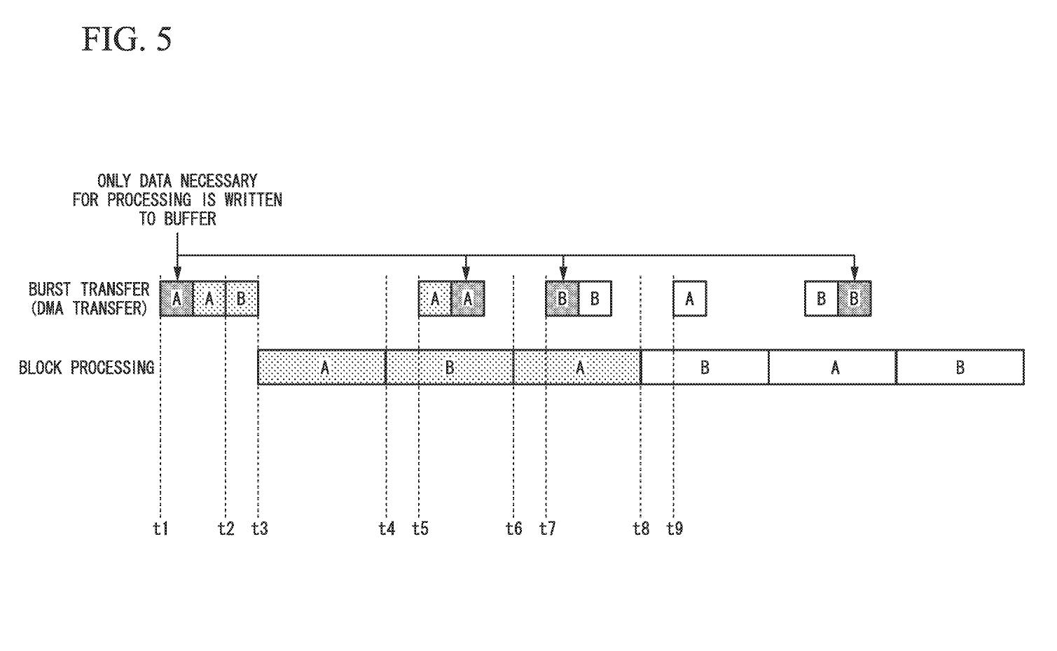

Next, processing timings in the data processing apparatus 1 in accordance with the first preferred embodiment of the present invention will be described. FIG. 5 is a timing chart illustrating an example of the processing timing for each block to be executed in the data processing apparatus 1 in accordance with the first preferred embodiment of the present invention. In the data processing apparatus 1, the image processing unit 80 alternately reads data for block processing stored in the two buffers (the buffer A (30) and the buffer B (40)) of the buffer unit 34 via the buffer read circuit 60, and performs block processing of the read data. Here, the processing timings of the data processing apparatus 1 when the data for block processing is stored in each buffer as shown in FIG. 4 will be described.

First, at a timing t1, the DMA I/F 10 acquires data for block processing of (Two Burst Widths×Number of Lines) determined by the traffic calculation unit 50 from the external memory 2 by a first DMA transfer (burst transfer). The buffer write circuit 20 stores data for block processing input from the DMA I/F 10 in the buffer A (30) based on information of the data for block processing input from the traffic calculation unit 50. Here, as shown in FIG. 4, the valid data for block processing included in the first burst width and the data for block processing included in the second burst width are stored in the buffer A (30).

Thereafter, if storing of the data for block processing in the buffer A (30) is completed, the DMA I/F 10 continuously acquires the data for block processing of (One Burst Width×Number of lines) determined by the traffic calculation unit 50 from the external memory 2 by a second DMA transfer at a timing t2. The buffer write circuit 20 stores the data for block processing input from the DMA I/F 10 in the buffer B (40) based on the information of the data for block processing input from the traffic calculation unit 50. Here, the data for block processing included in the third burst width as shown in FIG. 4 is stored in the buffer B (40).

If the data for block processing is stored in the buffer A (30) by the DMA transfer, the image processing unit 80 starts the block processing of the block 5 by reading the data for block processing to be used in the block processing of the block 5 stored in the buffer A (30) via the buffer read circuit 60 at a timing t3.

Thereafter, because the data for block processing is already stored in the buffer B (40) when the block processing of the block 5 using the data for block processing stored in the buffer A (30) is completed, the image processing unit 80 continues the block processing of the block 5 by continuously reading the data of block processing stored in the buffer B (40) via the buffer read circuit 60 at a timing t4.

Thereafter, when the block processing of the block 5 using the data for block processing stored in the buffer A (30) is completed and the data for block processing stored in the buffer A (30) is unnecessary for the block processing of the block 5, the DMA I/F 10 continuously acquires last data for block processing to be used in the block processing of the block 5 from the external memory 2 by a third DMA transfer at a timing t5. Because the traffic calculation unit 50 determines that the last data for block processing can be stored in the same buffer unit 34 as the data for block processing included in the fourth burst width and the valid data for block processing included in the fifth burst width, the DMA I/F 10 acquires data of block processing of (Two Burst Widths×Number of Lines) in the third DMA transfer. The buffer write circuit 20 stores the data for block processing input from the DMA I/F 10 in the buffer A (30) based on information of the data for block processing input from the traffic calculation unit 50. Here, the data for block processing included in the fourth burst width and the valid data for block processing included in the fifth burst width as shown in FIG. 4 are stored in the buffer A (30).

When storing of the last data for block processing in the buffer A (30) is completed, the DMA I/F 10 and the buffer write circuit 20 of the data processing apparatus 1 are reset and a preparation for DMA-transferring data necessary for block processing of the next block 6 to be processed from the external memory is started. Because the last data for block processing to be used in the block processing of the block 5 is stored in the buffer A (30), the data for block processing to be used in the block processing of the block 6 is stored in order from the buffer B (40). More specifically, the data is stored in the two buffers via the DMA I/F 10 and the buffer write circuit 20 in the order of Buffer B (40)→Buffer A (30)→Buffer B (40) as shown in FIG. 4.

Thereafter, because the data for block processing is already stored in the buffer A (30) when the block processing of the block 5 using the data for block processing stored in the buffer B (40) is completed, the image processing unit 80 continues the block processing of the block 5 by continuously reading the last data of block processing stored in the buffer A (30) via the buffer read circuit 60 at a timing t6.

In the data processing apparatus 1, when the block processing of the block 5 using the last data for block processing is started as shown in the processing timings of FIG. 5, the data for block processing stored in the buffer B (40) is already unnecessary for the block processing of the block 5. Accordingly, when the data for block processing stored in the buffer B (40) is unnecessary for the block processing of the block 5, the DMA I/F 10 continuously acquires data for block processing of (Two Burst Widths×Number of Lines) determined by the traffic calculation unit 50 from the external memory 2 by the first DMA transfer in the block processing of the block 6 at a timing t7. The buffer write circuit 20 stores the data for block processing input from the DMA I/F 10 in the buffer B (40) based on information of the data for block processing input from the traffic calculation unit 50. Here, the valid data for block processing included in the first burst width and the data for block processing included in the second burst width as shown in FIG. 4 are stored in the buffer B (40).

Thereafter, after the block processing of the block 5 using the last data for block processing stored in the buffer A (30) is completed, the image processing unit 80 is continuously in a state in which the block processing of the block 6 is started. In the data processing apparatus 1, when the image processing unit 80 is in a state in which the block processing of the block 6 can be started as shown in the processing timings of FIG. 5, data necessary for the block processing of the block 6 is already stored in the buffer B (40). At a timing t8, the image processing unit 80 starts the block processing of the block 6 by reading the data for block processing to be used in the block processing of the block 6 stored in the buffer B (40) via the buffer read circuit 60.

When the data for block processing stored in the buffer A (30) is unnecessary for the block processing of the block 5, the DMA I/F 10 continuously acquires the data for block processing of (One Burst Width×Number of Lines) determined by the traffic calculation unit 50 from the external memory 2 by the second DMA transfer in the block processing of the block 6 at a timing t9. The buffer write circuit 20 stores the data for block processing input from the DMA I/F 10 in the buffer A (30) based on the information of the data for block processing input from the traffic calculation unit 50. Here, the data for block processing included in the third burst width as shown in FIG. 4 is stored in the buffer A (30).

In the data processing apparatus 1 in accordance with the first preferred embodiment of the present invention as described above, when the last data of block processing currently being processed is stored in the buffer unit 34, a state in which a buffer to be used to store data for block processing of the next block can be used is already reached. Thereby, in the data processing apparatus 1 in accordance with the first preferred embodiment of the present invention, it is possible to pre-store data to be used for the block processing of the next block. Thereby, it is possible to start the processing of the next block upon completion of the processing of a block currently being processed, and eliminate a loss time in which the image processing unit 80 waits for block processing to be started.

According to the preferred embodiment of the present invention as described above, a small storage capacity for storing fractional data, which is less than a break (transfer unit) in a transfer when data necessary for processing is transferred, is added to the buffer. When the data is transferred, the fractional data, which is less than the transfer unit, is pre-stored in the buffer by switching a data transfer method based on the added storage capacity and an amount of valid data to be used in processing. Thereby, the data necessary for the processing is arranged across a transfer unit in which the data is transferred and the processing of the fractional data, which is less than the transfer unit, is rapidly completed, so that a loss time occurring due to waiting for the next processing to be started can be reduced. Thereby, when processing is performed for each divided block, it is possible to reduce loss time during each block processing and shorten processing time. The configuration of the preferred embodiment of the present invention is effective in a data processing apparatus in which a data transfer, that is, writing of data to the buffer unit 34 by the DMA I/F 10 and the buffer write circuit 20, is fast in an internal processing time, that is, a processing time of the image processing unit 80.

In the preferred embodiment of the present invention, data is stored in the buffer based on an amount of valid data to be used in processing. Thereby, it is possible to easily store only valid data to be used in the processing in the buffer without increasing a buffer size. Thereby, it is possible to suppress an increase in a circuit scale of the data processing apparatus.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the invention is not to be considered as being limited by the foregoing description, and is only limited by the scope of the claims.

What is claimed is:

1. A data processing apparatus comprising:
a data acquisition unit that acquires data for each predetermined unit of acquiring data;
a plurality of buffer units that include a storage capacity and an additional storage capacity, the storage capacity storing an amount of data acquired by the data acquisition unit in one of the predetermined unit of acquiring data, the additional storage capacity storing an amount of data less than the predetermined unit of acquiring data;
a valid data amount calculation unit that calculates an amount of valid data within the data acquired by the data acquisition unit, the valid data amount calculation unit outputting valid data information indicating whether or not the data acquired by the data acquisition unit is valid data; and
a data write control unit that controls writing of the data acquired by the data acquisition unit to one of the plurality of buffer units by exclusively controlling the plurality of buffer units,
wherein the valid data amount calculation unit determines the number of the units of acquiring data to be acquired by the data acquisition unit in one data acquisition based on the calculated amount of valid data and the additional storage capacity provided in the buffer unit,
the data acquisition unit acquires data included in the units of acquiring data, the number of which is determined by the valid data amount calculation unit, and
the data write control unit controls whether or not to write the data to one of the plurality of buffer units based on the valid data information output from the valid data amount calculation unit.

2. The data processing apparatus according to claim 1, wherein the additional storage capacity provided in the buffer unit is a storage capacity determined based on an acquisition time necessary for the data acquisition unit to acquire data of which an amount is less than the unit of acquiring data, and a processing time necessary to process data of which an amount is less than the unit of acquiring data.

3. The data processing apparatus according to claim 2, wherein
the valid data amount calculation unit sets the number of the units of acquiring data in one data acquisition by the data acquisition unit to 2 if the amount of valid data is equal to or less than the additional storage capacity, and
the data acquisition unit acquires data included in two continuous units of acquiring data.

4. The data processing apparatus according to claim 3, wherein the valid data amount calculation unit sets the number of units of acquiring data in one data acquisition by the data acquisition unit to 1 if the amount of valid data is greater than the additional storage capacity.

5. The data processing apparatus according to claim 4, wherein the data write control unit controls only data indicated as valid data by the valid data information output from the valid data amount calculation unit within the data acquired by the data acquisition unit to be written to one of the plurality of buffer units.

6. The data processing apparatus according to claim 5, wherein the data write control unit outputs a data write control signal to one of the plurality of buffer units when data indicated as valid data by the valid data information output from the valid data amount calculation unit within the data acquired by the data acquisition unit is written to one of the plurality of buffer units.
